(19) United States
(12) Patent Application Publication
(10) Pub. No.: US 2008/0180039 A1
(43) Pub. Date: Jul. 31, 2008

(54) LED DRIVE CIRCUIT

(75) Inventor: Hiroyuki Masuko, Chiba-shi (JP)

Correspondence Address: BRINKS HOFER GILSON & LIONE, P.O. BOX 10395, CHICAGO, IL, 60610, US

(73) Assignee: Seiko Instruments Inc., Chiba-shi (JP)

(21) Appl. No.: 12/015,877

(22) Filed: Jan. 17, 2008

(30) Foreign Application Priority Data
Jan. 18, 2007 (JP) JP2007-008948

(51) Int. Cl. H05B 37/02

(52) U.S. Cl. 315/291

(57) ABSTRACT

Even if an input voltage is higher than an output voltage, the luminance of an LED is so controlled as to be held constant. When an input voltage Vin becomes higher than an output voltage Vout due to a variation in a threshold voltage Vf of an LED (21) so that an LED drive circuit does not conduct a step-up operation, the operation of the LED drive circuit switches from a step-up type switching regulator operation to a voltage regulator operation. As a result, the LED drive circuit normally operates.

### FIELD OF THE INVENTION

The present invention relates to an LED drive circuit that drives LEDs.

### DESCRIPTION OF RELATED ART

There have been now widely employed liquid crystal displays in portable devices such as cellular phones. In the liquid crystal displays, light emitting diodes (LEDs) have been widely used as light emitting elements for backlight.

The LED emits a light in such a manner that a voltage that is equal to or higher than a threshold voltage (Vf) of the LED is applied between an anode terminal and a cathode terminal to make an LED drive current that drives the LED flow between the anode terminal and the cathode terminal. The luminance of the LED changes according to the current value of the LED drive current.

In order to improve the quality of the liquid crystal display, there is required that the LED drive current is controlled to be held constant, and the luminance of the LED is held constant. As a technique for controlling the LED drive current, there is provided an LED drive circuit that drives the LED in a step-up type switching regulator system (for example, refer to JP 2003-151784 A).

Now, a conventional LED drive circuit will be described. FIG. 7 is a diagram showing the conventional LED drive circuit.

The LED drive circuit that drives an LED 79 has an input terminal to which an input voltage Vin is applied, and an output terminal from which an output voltage Vout is output.

An oscillator circuit 75 outputs an output signal Vosc of a given frequency. The output voltage Vout is applied to the LED 79 and a resistor 80, and an LED drive current based on the output voltage Vout flows in the LED 79 and the resistor 80. The LED drive current is converted into a voltage Vfb by the resistor 80. An error amplifier 76 compares the voltage Vfb with a reference voltage Vref of a reference voltage circuit 77. The error amplifier 76 increases an output voltage Verr1 of the error amplifier 76 when Vfb >Vref is established, and decreases the output voltage Verr1 when Vfb<Vref is established. A comparator 74 compares the output voltage Verr1 of the error amplifier 76 with the output signal Vosc of the oscillator circuit 75. The comparator 74 sets a pulse voltage Vpre to “Lo” when Verr1>Vosc is established, and sets the pulse voltage Vpre to “Hi” when Verr1<Vosc is established.

The pulse voltage Vpre of the comparator 74 is input to a control circuit 73. The control circuit 73 outputs an output voltage Vbufn and an output voltage Vbufp to the gates of transistors 71 and 72, respectively, so as not to turn on the transistors 71 and 72 at the same time. The transistors 71 and 72 are alternately turned on on the basis of the output voltages Vbufn and Vbufp, respectively. When the transistor 72 is off, and the transistor 71 is on, a current flows into an inductor 81 from an input power supply 70 to store energy in the inductor 81. Also, when the transistor 72 is on, and the transistor 71 is off, a current flows into the LED 79 and the resistor 80 through the transistor 72 from the inductor 81 to output a constant output voltage Vout.

### DISCLOSURE OF INVENTION

### Problem to Be Solved by the Invention

Incidentally, the threshold voltage Vf of the LED 79 are varied according to the drive current dependency, the operating temperature dependency, or the manufacture variation.

In the conventional LED drive circuit of the step-up switching regulator system, when Vin<Vout, the step-up operation is conducted, thereby making it possible to conduct a normal operation. However, when Vin>Vout is established due to variation in the voltage Vf of the LED 79, it is not possible to conduct a normal operation. Accordingly, because the LED drive circuit cannot hold the output voltage Vout constant, the LED drive current is not normally controlled, and the luminance of the LED 79 is not so controlled as to be held constant.

The present invention has been made in view of the above circumstances, and therefore an object of the present invention is to provide an LED drive circuit that is capable of controlling the luminance of the LED 21 so as to be held constant even if the input voltage is higher than the output voltage.

### Means for Solving Problem

In order to solve the above-mentioned problems, the present invention provides an LED drive circuit that drives an LED that is connected in series to a resistor, including: a step-up type switching regulator portion including: a first transistor that outputs an output voltage; a second transistor; a reference voltage circuit that generates a reference voltage; a first error amplifier that compares the output voltage which is divided with the reference voltage; a pulse generating circuit that generates a pulse so as to hold the output voltage constant on the basis of a comparison result of the first error amplifier; and a control circuit that controls the first transistor and the second transistor on the basis of the pulse when a value of an input voltage is lower than the value of the output voltage; and a voltage regulator portion including: the first transistor; the reference voltage circuit; a second error amplifier that compares the output voltage which is divided with the reference voltage; and the control circuit that controls the first transistor so as to hold the output voltage constant on the basis of the comparison result of the second error amplifier when the value of the input voltage is equal to or higher than the value of the output voltage.

### EFFECT OF THE INVENTION

In the present invention, even if the input voltage becomes higher than the output voltage so that the LED drive circuit does not conduct the step-up operation, the operation of the LED drive circuit switches from the step-up type switching regulator operation to the voltage regulator operation. As a result, the LED drive circuit normally operates, thereby making it possible to hold the output voltage constant. Hence, the LED drive current is so controlled as to be held constant, and the luminance of the LED is so controlled as to be held constant.

### BRIEF DESCRIPTION OF THE DRAWINGS

FIG. 1 shows a diagram showing an LED drive circuit according to a first embodiment;

FIG. 2 shows a diagram showing a control circuit according to the first embodiment;

FIG. 3 shows a diagram showing an LED drive circuit according to a second embodiment;

FIG. 4 shows a diagram showing a control circuit according to the second embodiment;

FIG. 5 shows a diagram showing an LED drive circuit according to a third embodiment;

FIG. 6 shows a diagram showing a control circuit according to the third embodiment; and

FIG. 7 shows a diagram showing a conventional LED drive circuit.

### DETAILED DESCRIPTION OF THE PREFERRED EMBODIMENTS

### First Embodiment

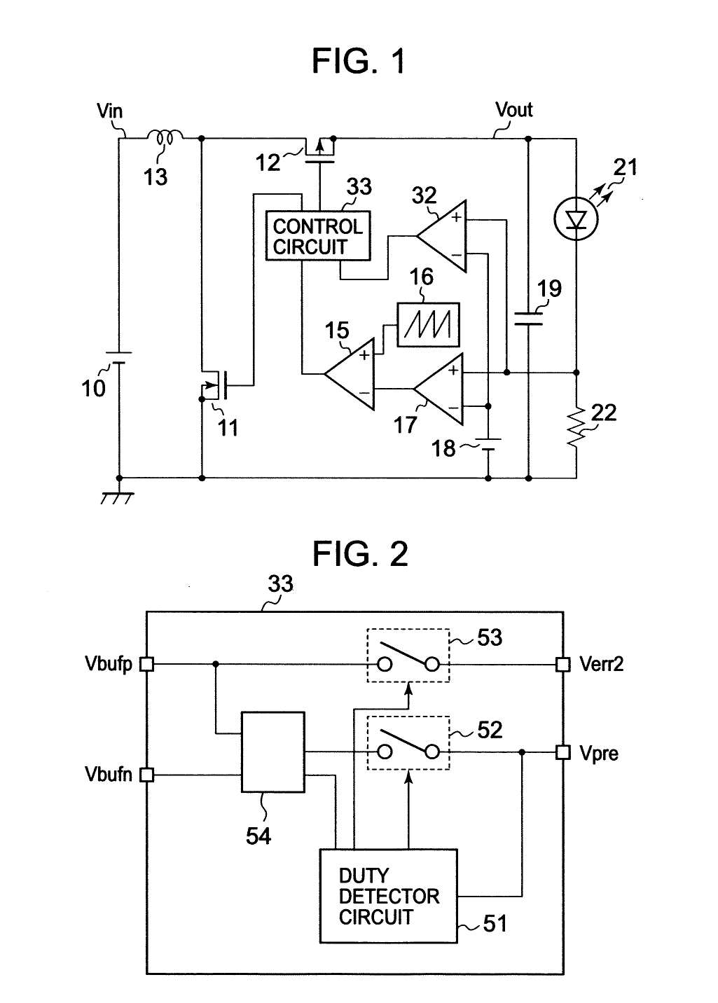

First, a description will be given of the structure of an LED drive circuit according to the first embodiment. FIG. 1 is a diagram showing an LED drive circuit according to the first embodiment.

The LED drive circuit has an input power supply 10 and a DC/DC converter. The DC/DC converter includes an NMOS transistor 11, a PMOS transistor 12, an inductor 13, a comparator 15, an oscillator circuit 16, an error amplifier 17, a reference voltage circuit 18, a capacitor 19, an error amplifier 32, and a control circuit 33. A load circuit includes an LED 21 and a resistor 22.

The DC/DC converter is connected to the input power supply 10 and the load circuit.

The inductor 13 has one end connected to the input terminal, and another end connected to the drains of the transistor 11 and the transistor 12. The source of the transistor 11 is connected to the ground. The source of the transistor 12 is connected to the output terminal. The capacitor 19 has one end connected to an output terminal, and another end connected to the ground. The LED 21 has one end connected to the output terminal, and another end (voltage Vfb) connected to the resistor 22. The resistor 22 has one end connected to the ground, and another end (voltage Vfb) connected to the LED 21. The error amplifier 17 and the error amplifier 32 have inverting input terminals connected to the output terminal (reference voltage Vref) of the reference voltage circuit 18, and non-inverting input terminals connected to another end (voltage Vfb) of the LED 21, respectively. The comparator 15 has an inverting input terminal connected to the output terminal (output voltage Verr1) of the error amplifier 17, and a non-inverting input terminal connected to the output terminal (output voltage Vosc) of the oscillator circuit 16. The control circuit 33 has a first input terminal connected to the output terminal (pulse voltage Vpre) of the comparator 15, a second input terminal connected to the output terminal (output voltage Verr2) of the error amplifier 32, a first output terminal (output voltage Vbufp) connected to the gate of the transistor 11, and a second output terminal (voltage Vbufn) connected to the gate of the transistor 12.

The reference voltage Vref is a value obtained by multiplying a value of the LED drive current optimum to the LED 21 by a value of the resistance of the resistor 22.

Subsequently, the structure of the control circuit 33 according to the first embodiment will be described. FIG. 2 is a diagram showing a control circuit according to the first embodiment.

The control circuit 33 includes a 100% duty detector circuit 51, a switch 52, a switch 53, and a buffer 54.

The control circuit 33 has a first input terminal applied with the pulse voltage Vpre of the comparator 15, and a second input terminal applied with the output voltage Verr2 of the error amplifier 32. The control circuit 33 outputs the output voltage Vbufp from the first output terminal and the voltage Vbufn from the second output terminal.

The first input terminal is connected to the buffer 54 through the switch 52, and also connected to the 100% duty detector circuit 51. The second input terminal is connected to the first output terminal through the switch 53. The 100% duty detector circuit 51 is connected to the switch 52, the switch 53, and the buffer 54. The buffer 54 is connected to the first output terminal and the second output terminal.

Subsequently, the operation of the LED drive circuit according to the first embodiment will be described.

In this embodiment, the LED drive circuit, which drives the LED 21, has an input terminal applied with the input voltage Vin, and an output terminal from which the output voltage Vout is output.

Also, the transistors 11 and 12, the inductor 13, the comparator 15, the oscillator circuit 16, the error amplifier 17, the reference voltage circuit 18, the capacitor 19, and the control circuit 33 in the DC/DC converter of the LED drive circuit function as a step-up type switching regulator portion. Also, the transistor 12, the reference voltage circuit 18, the capacitor 19, the error amplifier 32, and the control circuit 33 function as a voltage regulator portion.

The oscillator circuit 16 outputs an output signal Vosc of a given frequency. The output voltage Vout is applied to a load circuit, and an LED drive current based on the output voltage Vout flows into the load circuit. The LED drive current is converted into a voltage Vfb by means of the resistor 22. The error amplifier 17 compares the voltage Vfb obtained by dividing the output voltage Vout with the reference voltage Vref that has been generated by the reference voltage circuit 18. When Vfb>Vref is established, the error amplifier 17 increases the output voltage Verr1 of the error amplifier 17. When Vfb<Vref is established, the error amplifier 17 decreases the output voltage Verr1. The same is applied to the output voltage Verr2 of the error amplifier 32. The comparator 15 compares the output voltage Verr1 of the error amplifier 17 with the output signal Vosc of the oscillator circuit 16. When Verr1 >Vosc is established, the comparator 15 sets the pulse voltage Vpre to “Lo”, and when Verr1 <Vosc is established, the comparator 15 sets the pulse voltage Vpre to “Hi”, thereby generating the pulse.

### A Case of Vin<Vout]

Since a state where the pulse voltage Vpre of the comparator 15 is “Hi” is not always maintained, the 100% duty detector circuit 51 determines that the voltage value of the input voltage Vin is lower than the voltage value of the output voltage Vout, turns on the switch 52, and turns off the switch 53. Hence, the pulse voltage Vpre of the comparator 15 is input to the buffer 54 of the control circuit 33 through the switch 52. The buffer 54 outputs the output voltages Vbufn and Vbufp to the gates of the transistors 11 and 12 on the basis of the pulse voltage Vpre of the comparator 15, respectively, so as not to turn on the transistors 11 and 12 at the same time. The transistors 11 and 12 are alternately turned on on the basis of the output voltages Vbufn and Vbufp. When the transistor 12 is off, and the transistor 11 is on, a current flows into the inductor 13 from the input power supply 10 to store energy in the inductor 13. Also, when the transistor 12 is on, and the transistor 11 is off, a current flows into the load circuit from the inductor 13 through the transistor 12, and the transistor 12 outputs a constant output voltage Vout. The output voltage Vout is smoothed by the capacitor 19. The output voltage Vout is a voltage obtained by adding the threshold voltage Vf of the LED 21 to the voltage Vfb. The LED drive circuit drives the LED 21 by the aid of the output voltage Vout. The operation of the LED drive circuit is called “step-up type switching regulator operation”.

In this embodiment, the 100% duty detector circuit 51 of the control circuit 33 monitors the duty of the pulse voltage Vpre. The 100% duty detector circuit 51 determines whether the operation of the LED drive circuit is set to the step-up switching regulator operation or the voltage regulator operation, on the basis of the monitor results.

### [A Case of Vin≧Vout]

When a period of time during which the pulse voltage Vpre of the comparator 15 is “Hi” is maintained for a given period of time (for example, 1 msec), that is, when a period of time during which the duty of the pulse voltage Vpre is 100% is maintained for the given period of time, the 100% duty detector circuit 51 determines that the value of the input voltage Vin is equal to or higher than the value of the output voltage Vout. Then, the 100% duty detector circuit 51 turns off the switch 52 and turns on the switch 53. Hence, the output voltage Verr2 of the error amplifier 32 is output to the transistor 12 through the switch 53 as the output voltage Vbufp. Also, the 100% duty detector circuit 51 controls the buffer 54, and turns off the transistor 11. When the output voltage Vout becomes high, the voltage Vfb becomes high, and the output voltage Verr2 (output voltage Vbufp of the control circuit 33) of the error amplifier 32 becomes high, a voltage between the gate and the source of the transistor 12 becomes low, and the on-resistance of the transistor 12 becomes high. Then, the LED drive circuit decreases the output voltage Vout to hold the output voltage Vout constant, and the transistor 12 outputs the output voltage Vout. Also, when the output voltage Verr2 of the error amplifier 32 is decreased, the LED drive circuit increases the output voltage Vout to hold the output voltage Vout constant, and the transistor 12 outputs the output voltage Vout. The output voltage Vout is smoothed by the capacitor 19. The LED drive circuit drives the LED 21 by the aid of the output voltage Vout. The above operation of the LED drive circuit is called “voltage regulator operation”.

That is, the control circuit 33 sets the operation of the LED drive circuit to the step-up type switching regulator operation when Vin<Vout is established. The control circuit 33 sets the operation of the LED drive circuit to the voltage regulator operation when Vin≧Vout is established.

### Second Embodiment

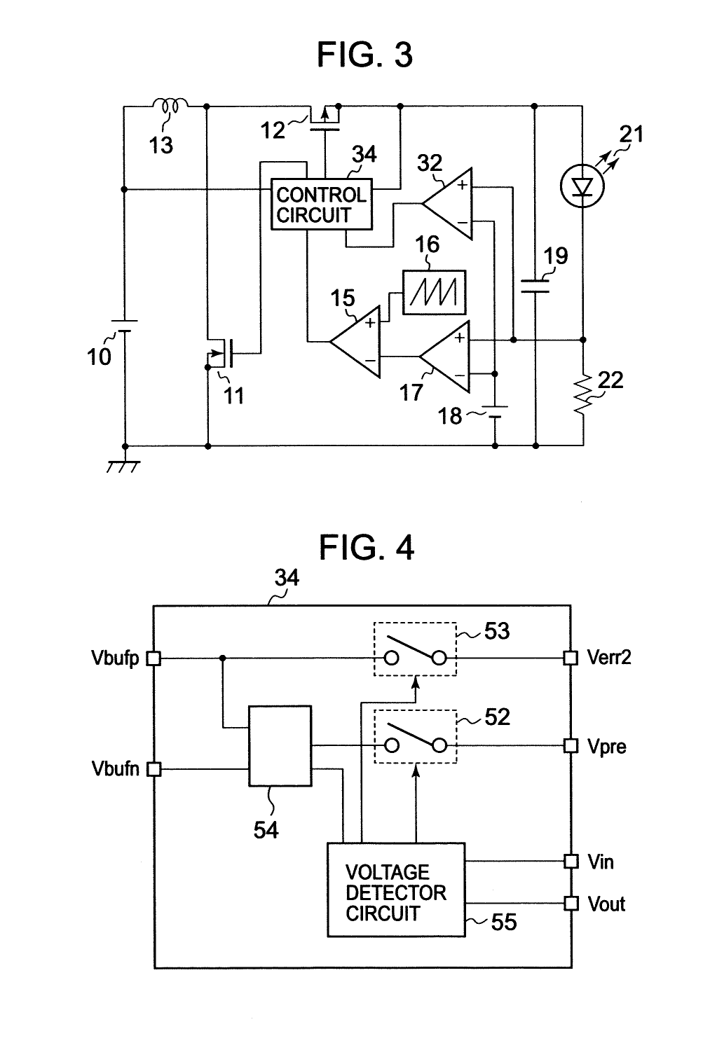

Subsequently, the structure of an LED drive circuit according to a second embodiment will be described. FIG. 3 is a diagram showing the LED drive circuit according to the second embodiment.

As compared with the LED drive circuit according to the first embodiment, the LED drive circuit according to the second embodiment changes the control circuit 33 to a control circuit 34. Also, the control circuit 34 is connected to the input terminal (input voltage Vin) and the output terminal (output voltage Vout).

Now, the structure of the control circuit 34 according to the second embodiment will be described. FIG. 4 is a diagram showing the control circuit according to the second embodiment.

As compared with the control circuit 33 according to the first embodiment, the control circuit 34 of the second embodiment changes the 100% duty detector circuit 51 to a voltage detector circuit 55. Also, the voltage detector circuit 55 is connected to the input terminal (input voltage Vin) and the output terminal (output voltage Vout).

Then, the operation of the LED drive circuit according to the second embodiment will be described.

The oscillator circuit 16 outputs the output signal Vosc of a given frequency. The output voltage Vout is applied to a load circuit, and an LED drive current based on the output voltage Vout flows into the load circuit. The LED drive current is converted into the voltage Vfb by means of the resistor 22. The error amplifier 17 compares the voltage Vfb obtained by dividing the output voltage Vout with the reference voltage Vref that has been generated by the reference voltage circuit 18. When Vfb>Vref is established, the error amplifier 17 increases the output voltage Verr1 of the error amplifier 17. When Vfb<Vref is established, the error amplifier 17 decreases the output voltage Verr1. The same is applied to the output voltage Verr2 of the error amplifier 32. The comparator 15 compares the output voltage Verr1 of the error amplifier 17 with the output signal Vosc of the oscillator circuit 16. When Verr1>Vosc is established, the comparator 15 sets the pulse voltage Vpre to “Lo”, and when Verr1<Vosc is established, the comparator 15 sets the pulse voltage Vpre to “Hi”, thereby generating the pulse.

In this embodiment, the voltage detector circuit 55 of the control circuit 34 compares the input voltage Vin with the output voltage Vout. The voltage detector circuit 55 determines whether the operation of the LED drive circuit is set to the step-up type switching regulator operation or the voltage regulator operation, on the basis of the comparison results.

### [A Case of Vin<Vout]

The voltage detector circuit 55 determines that the value of the input voltage Vin is lower than the value of the output voltage Vout, turns on the switch 52, and turns off the switch 53. Hence, the LED drive circuit conducts the step-up type switching regulator operation as in the first embodiment described above.

### [A Case of Vin≧Vout]

The voltage detector circuit 55 determines that the value of the input voltage Vin is equal to or higher than the value of the output voltage Vout, turns off the switch 52, and turns on the switch 52. Hence, the LED drive circuit conducts the voltage regulator operation as in the first embodiment described above.

### Third Embodiment

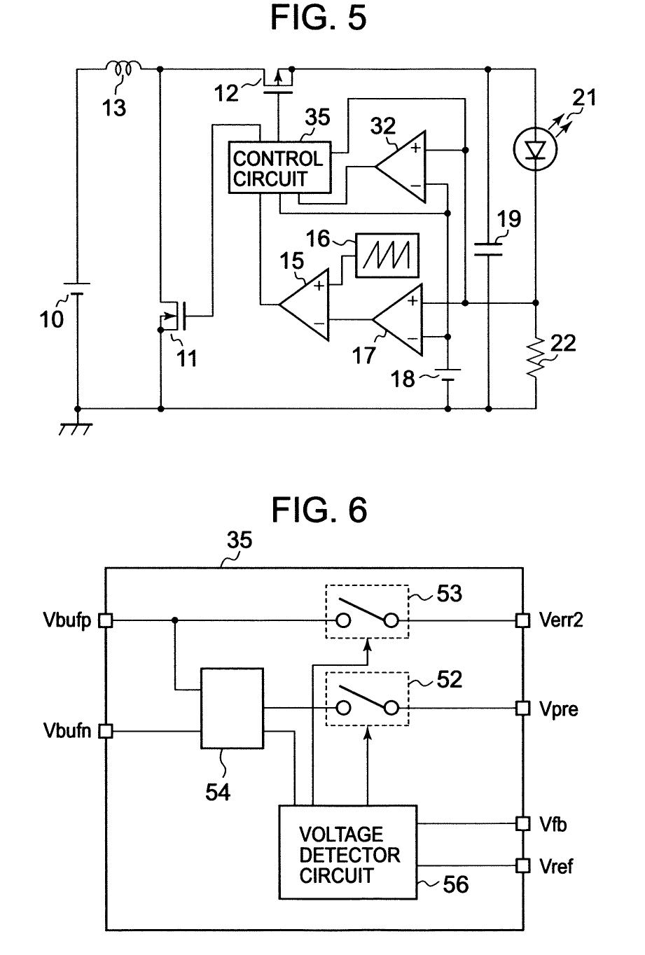

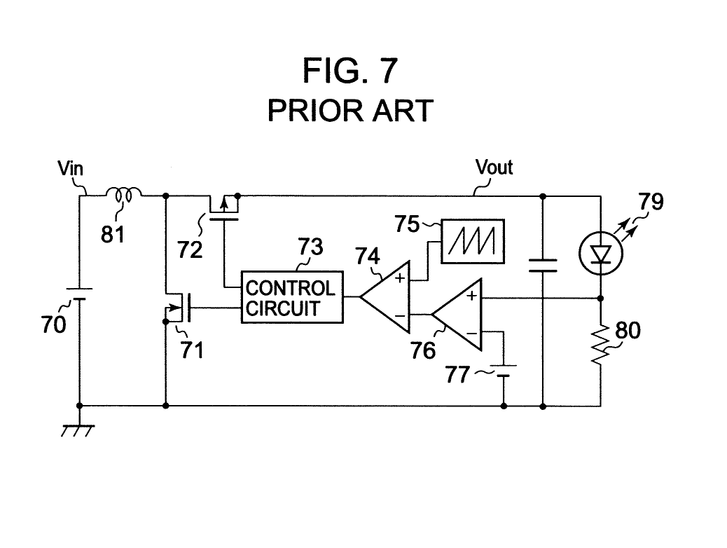

Then, the structure of an LED drive circuit according to a third embodiment will be described. FIG. 5 is a diagram showing the LED drive circuit according to the third embodiment.

As compared with the LED drive circuit according to the first embodiment, the LED drive circuit according to the third embodiment changes the control circuit 33 to a control circuit 35. Also, the control circuit 35 is connected to another end (voltage Vfb) of the LED 21 and the output terminal (reference voltage Vref) of the reference voltage circuit 18.

Then, the structure of the control circuit 35 according to the third embodiment will be described. FIG. 6 is a diagram showing the control circuit according to the third embodiment.

As compared with the control circuit 33 according to the first embodiment, the control circuit 35 according to the third embodiment changes the 100% duty detector circuit 51 to a voltage detector circuit 56. Also, the voltage detector circuit 56 is connected to another end (voltage Vfb) of the LED 21 and the output terminal (reference voltage Vref) of the reference voltage circuit 18.

Then, the operation of the LED drive circuit according to the third embodiment will be described.

The oscillator circuit 16 outputs the output signal Vosc of a given frequency. The output voltage Vout is applied to a load circuit, and an LED drive current based on the output voltage Vout flows into the load circuit. The LED drive current is converted into the voltage Vfb by means of the resistor 22. The error amplifier 17 compares the voltage Vfb obtained by dividing the output voltage Vout with the reference voltage Vref that has been generated by the reference voltage circuit 18. When Vfb>Vref is established, the error amplifier 17 increases the output voltage Verr1 of the error amplifier 17. When Vfb <Vref is established, the error amplifier 17 decreases the output voltage Verr1. The same is applied to the output voltage Verr2 of the error amplifier 32. The comparator 15 compares the output voltage Verr1 of the error amplifier 17 with the output signal Vosc of the oscillator circuit 16. When Verr1>Vosc is established, the comparator 15 sets the pulse voltage Vpre to “Lo”, and when Verr1<Vosc is established, the comparator 15 sets the pulse voltage Vpre to “Hi”, thereby generating the pulse.

In this embodiment, the voltage detector circuit 56 of the control circuit 35 compares the voltage Vfb with the reference voltage Vref. The voltage detector circuit 56 determines whether the operation of the LED drive circuit is set to the step-up type switching regulator operation or the voltage regulator operation, on the basis of the comparison results.

### [A Case of Vref≈Vfb and Vref<Vfb]

When the voltage Vfb that has been generated in the resistor 22 becomes higher than the reference voltage Vref by a given value, the voltage detector circuit 56 determines that the value of the input voltage Vin is lower than the value of the output voltage Vout, turns on the switch 52, and turns off the switch 53. Hence, the LED drive circuit conducts the step-up type switching regulator operation as in the above-mentioned first embodiment.

### [A Case of not Vref≈Vfb but Vref>Vfb]

When the voltage Vfb that has been generated in the resistor 22 becomes lower than the reference voltage Vref by a given value, the voltage detector circuit 56 determines that the value of the input voltage Vin is equal to or higher than the value of the output voltage Vout, turns off the switch 52, and turns on the switch 53. Hence, the LED drive circuit conducts the voltage regulator operation as in the first embodiment.

With the above operation, even if the input voltage Vin becomes higher than the output voltage Vout due to a variation in the threshold voltage Vf of the LED 21 so that the LED drive circuit does not conduct the step-up operation, the operation of the LED drive circuit switches from the step-up type switching regulator operation to the voltage regulator operation. As a result, the LED drive circuit normally operates, and the LED drive circuit can hold the output voltage Vout constant. Hence, the LED drive current is so controlled as to be held constant, and the luminance of the LED 21 is so controlled as to be held constant. Also, even if the input voltage Vin varies in a wide range, the LED drive circuit can hold the output voltage Vout constant.

1. An LED drive circuit that drives an LED that is connected in series to a resistor, comprising:
a step-up type switching regulator portion including:
a first transistor that outputs an output voltage;
a second transistor;
a reference voltage circuit that generates a reference voltage;
a first error amplifier that compares the output voltage which is divided with the reference voltage;
a pulse generating circuit that generates a pulse so as to hold the output voltage constant on the basis of a comparison result of the first error amplifier; and
a control circuit that controls the first transistor and the second transistor on the basis of the pulse when a value of an input voltage is lower than the value of the output voltage; and
a voltage regulator portion including:
the first transistor;
the reference voltage circuit;
a second error amplifier that compares the output voltage which is divided with the reference voltage; and
the control circuit that controls the first transistor so as to hold the output voltage constant on the basis of the comparison result of the second error amplifier when the value of the input voltage is equal to or higher than the value of the output voltage.

2. An LED drive circuit according to claim 1, wherein the control circuit determines that the value of the input voltage is equal to or higher than the value of the output voltage when a period of time during which the duty of the pulse is 100% is maintained for a given period of time.

3. An LED drive circuit according to claim 1, wherein the control circuit determines that the value of the input voltage is equal to or higher than the value of the output voltage when the voltage that has been generated in the resistor is lower than the reference voltage by a given value.
